(19) United States
(12) Patent Application Publication
(10) Pub. No.: US 2010/0237626 A1
(43) Pub. Date: Sep. 23, 2010

(54) HINGED-BLADE CROSS-AXIS TURBINE FOR HYDROELECTRIC POWER GENERATION

(75) Inventor: William B. Hamner, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: HYDROVOLTS, INC., Seattle, WA (US)

(21) Appl. No.: 12/729,523

(22) Filed: Mar. 23, 2010

Related U.S. Application Data
(60) Provisional application No. 61/162,560, filed on Mar. 23, 2009.

(51) Int. Cl. F03B 13/00; F03B 3/14

(52) U.S. Cl. 290/54; 416/119

(57) ABSTRACT

A power generator comprising a generator drivably attached to a turbine. The turbine comprises a shaft rotatably mounted to a frame. Support plates drivably engage the shaft and a plurality of blades are pivotably connected to the support plates. Each blade has a distal edge that is disposed adjacent the shaft when the blade is pivoted to a stopped position. During operation the blades revolve about the shaft axis. Each blade is held in the stopped position by the flow stream for a portion of the revolution and is pivoted away from the stopped position for the remainder of the revolution. In one embodiment, blade stops limit the outward pivot of the blades to improve efficiency. In another embodiment a second set of blades are provided and rotationally offset from the first blades. In another embodiments the support plates are configured as rotors for the generator.

### CROSS-REFERENCE TO RELATED APPLICATION

This application claims the benefit of Provisional Application No. 61/162560, filed Mar. 23, 2009, the entire disclosure of which is hereby incorporated by reference in its entirety.

### BACKGROUND

Devices have been used to harness the energy of moving fluids such as water and air for more than six thousand years. For example, waterwheels have been used for thousands of years to harness power from moving water sources. According to some sources, the earliest known water turbine dates to around the turn of the fourth century wherein a pair of helix-turbine mill sites were found dating to around the turn of the fourth century. A horizontal waterwheel with angled blades was installed at the bottom of a water-filled circular shaft, such that water from the mill-race acted on the submerged waterwheel to generate power.

The primary aim of a water turbine is to harness the energy present in a consistently moving fluid stream. The means by which energy is extracted vary. In general, water turbines may be categorized as either reaction-type turbines wherein water pressure acts on the blades of the turbine to produce work, or as impulse-type turbines which change the velocity of a fluid jet to produce work.

Early waterwheel power systems involve the partial submersion of a rotatable wheel having spaced paddles into a flow of water such as a river or stream. The water exerts force on the submerged paddles as it flows. This force rotates the wheel about a central axis to which the paddles are attached. There are several drawbacks to this design. For example, typically only a small fraction of the paddles are exposed to the flowing water. As a result, a great deal of inefficiency exists because the water must exert force to turn all elements of the device, meaning less energy is captured by the turning of the central axis. The proposed invention has its entire structure exposed to the flow and can capture much more energy for a given amount of construction material.

Another method employed to capture energy from moving water uses propeller-type turbines having a plurality of curved blades that are attached to either a single pole or encased within a housing. This turbine is positioned with its axis parallel to the current. This method also comes with significant drawbacks, including:
Manufacturing is difficult because the blades use complex curved shapes. This increases cost and decreases manufacturing feasibility.
Installing such devices is difficult, because they are typically held in place by a large rigid structure either attached to the channel bottom or suspended from the water surface. This requires substantial additional construction The proposed invention does not require similar construction as it can be held in place using simple tethers or ropes.

Propeller-type rotors are based on lift rather than drag, thus they have a “stall speed” or minimum flow needed to start rotating. The proposed invention uses the push of the water and thus has no stall speed and rotates even in very slow currents depending on the generator or other load on the rotor.

Propeller rotors are circular but water channels are usually rectangular and therefore the rotors cannot fit tightly into the channel. The proposed invention has variable rectangular profile and can fit tightly into any rectangular channel

### SUMMARY

The present invention uses a cross-axis turbine with hinged blades for capturing energy from flowing fluids such as water and air. The captured energy can be used to perform mechanical work or to generate electricity. The rotor acts like a paddlewheel in which the paddles or blades are hinged so they rotate away from the current on the upstream stroke of the rotor and thus greatly reduce drag and increase efficiency of energy capture.

A water turbine is disclosed that is configured to be placed into a flow stream. The turbine includes a frame structure having a first end and a second end. A shaft is rotatably mounted to the frame structure to rotate about a shaft axis, the shaft extending between the first end and the second end of the frame structure. A first support plate is drivably attached to the shaft near the first end of the frame structure and a second support plate is drivably attached to the shaft a distance away from the first support plate. A plurality of blades extend between the first and second support plates, each blade having a proximal edge that is pivotably attached to the first and second support plates and a distal edge that is disposed adjacent the shaft when the blade is pivoted to a stopped position. During operation of the water turbine the blades are positioned transverse to the flow stream such that as the first blades revolve about the shaft axis each blade is held in the stopped position by the flow stream for approximately half of the revolution and is pivoted away from the stopped position for the remainder of the revolution.

In an embodiment of the invention the turbine includes between three and six planar blades. In an embodiment of the invention the distal edge of each blade is adjacent the shaft when the blade is in the stopped position.

In another embodiment, the turbine further includes a third support plate drivably attached to the shaft near the second end of the frame structure, and a second plurality of blades are pivotably attached to the first and second support plates, with a distal edge that is disposed adjacent the shaft when the blade is pivoted to a stopped position. The second plurality of blades may be rotationally offset from the other blades.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a front view of a hydroelectric generator having a four-blade water turbine in accordance with a first embodiment of the present invention;

FIG. 2 shows a cross-sectional view along section 2-2 of FIG. 1, showing the turbine in operation;

FIG. 3 is a kinematic view illustrating schematically the ideal motion of a single blade of the turbine shown in FIG. 1 at thirty-degree increments during operation;

FIG. 4 is a perspective view of the turbine shown in FIG. 1;

FIG. 5 is a partially exploded perspective view of the turbine shown in FIG. 1;

FIG. 6 is a perspective view of another embodiment of a turbine in accordance with the present invention, comprising a plurality of rotor sections having rotationally offset orientations;

FIG. 7 is a kinematic view illustrating schematically the motion of a single blade at thirty-degree increments during operation, for another embodiment of a turbine in accordance with the present invention that includes stops that constrain the rotation of the blades;

FIG. 8 is a cross-sectional end view of a turbine in accordance with FIG. 7; and

FIG. 9 illustrates another embodiment of a hydroelectric generator in accordance with the present invention.

### DETAILED DESCRIPTION

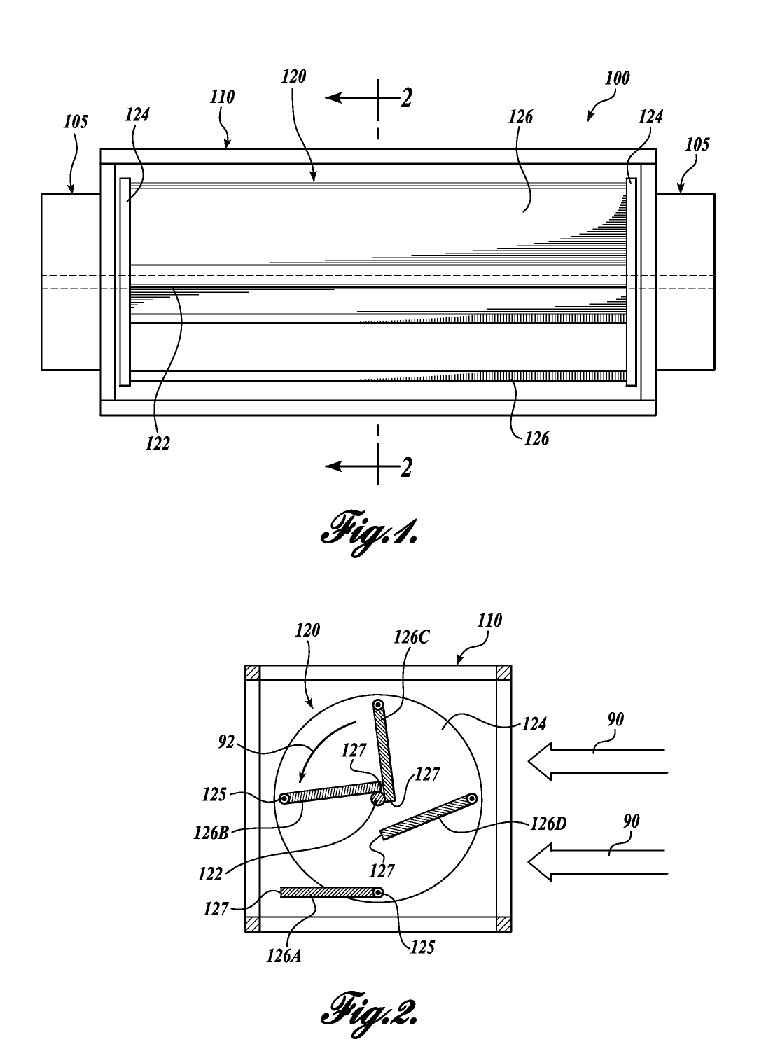

A hydroelectric power generator system 100 in accordance with the present invention is shown in FIG. 1. In this embodiment the system 100 comprises a water turbine 120 disposed in an optional frame structure 110. Although a simple open, rectangular frame structure 110 is shown, it will be appreciated that any suitable frame structure may alternatively be used, including for example a bifurcated frame comprising upright supports on either side of the turbine 120.

A pair of electric power generators 105 are attached to either end of the frame structure 110 in this embodiment. Although two power generators 105 are shown, it will be appreciated that a different number of generators may alternatively be used. It is believed that in many applications a single power generator 105 will be preferred.

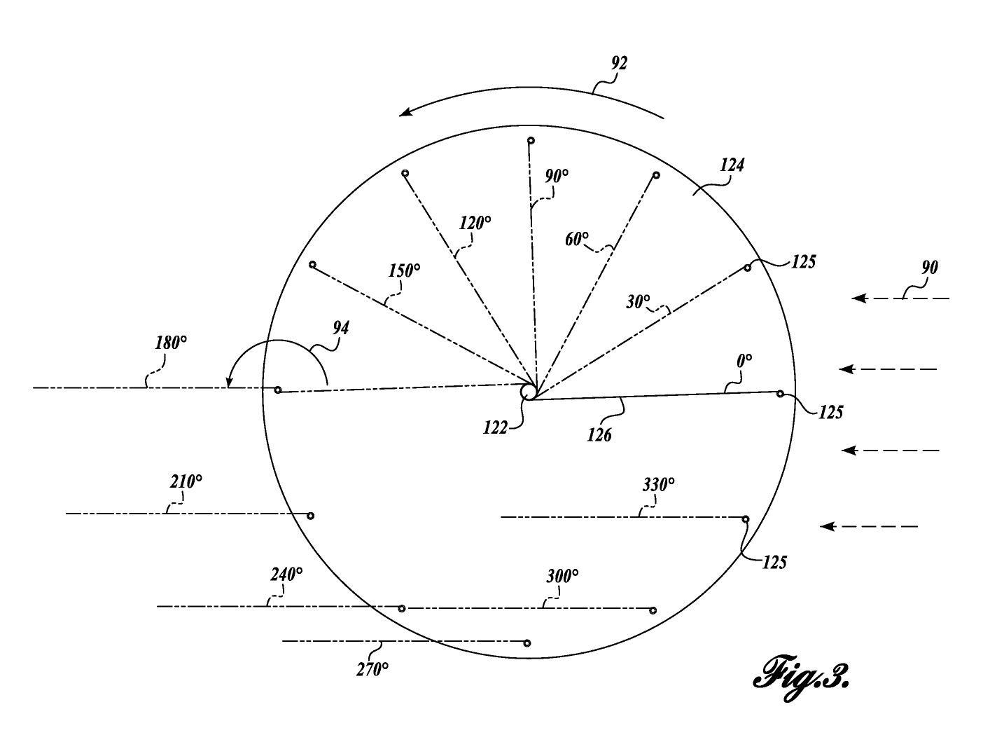

The novel flip-wing™ turbine 120 is rotatably mounted in the frame 110 through a turbine driveshaft 122 that is configured to drivably engage the generators 105. The turbine 120 includes oppositely disposed support plates 124 that are attached to rotationally drive the shaft 122. A plurality of generally planar blades 126 extend between the first and second support plates 124. In this embodiment the turbine 120 has four blades 126, although more or fewer blades may alternatively be used. The blades 126 are pivotably mounted to the support plates 124, preferably near the outer perimeter of the plates 124, and configured to pivot about a pivot axis 125 (see FIG. 2) that is parallel to the driveshaft 122 axis.

An end view of the turbine 120 through section 2-2 is shown in FIG. 2. In this embodiment, the support plates 124 are generally circular in shape. The blades 126 pivot about associated pivot axes 125 that are evenly spaced around the shaft 122 axis, e.g., at ninety-degree intervals. The four blades are identified as 126A, 126B, 126C and 126D and are referred to herein collectively as blades 126.

The blades 126 are positioned and sized such that the distal edge 127 of each blade 126 engages the shaft 122 when the blade 126 is pivoted inwardly. The inward-most pivot position is referred to herein as the stopped position. In this embodiment the blades 126 abut the shaft 122 in the stopped position, although it will be apparent that a separate stopping member, such as a peg or the like, may alternatively be provided on the support plates 124 near the shaft 122.

The fluid flow stream direction is indicated by arrows 90. In the position shown in FIG. 2 the water pressure holds the upper blade 126C in the stopped position (e.g., abutting the shaft 122), while the lower blade 126A is pivoted away from the stopped position by the water pressure. The water pressure tends to urge the forward blade 126D towards the stopped position, and gravity tends to maintain the trailing blade 126B in the stopped position. Therefore, water will tend to flow relatively freely through the lower portion of the turbine 120 (below the shaft 122), but will be substantially blocked by the upper blade 126C, producing a hydraulic force above the shaft 122, causing the turbine 120 to rotate about the shaft 122 axis, as indicated by arrow 92.

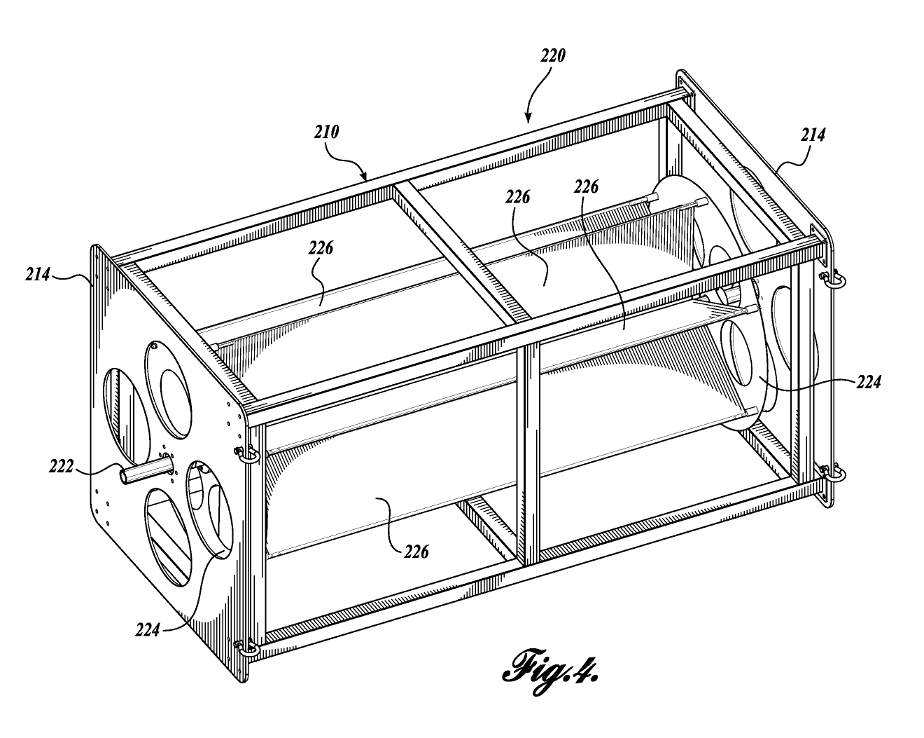

Refer now to the kinematic diagram of FIG. 3, which illustrates the motion of a single blade 126 through a complete revolution about the shaft axis 122, showing the ideal blade 126 position every thirty degrees (the other blades 126 are not shown, for clarity). The degree indicators refer to the relative angular position as the support plate 124 undergoes one revolution.

When the blade 126 pivot is above the shaft 122, the water pressure tends to hold the blade 126 in the stopped position (adjacent the shaft 122). After the blade 126 passes the 180° position, water pressure will “flip” the blade 126 (CCW in FIG. 3 as indicated by arrow 94). The blade 126 will then tend to remain parallel to the flow direction while the blade 126 pivot axis 125 is below the shaft 122. It will be appreciated that a consistent water flow stream generally perpendicular to the axis of rotation (shaft 122) will produce a significant fluid pressure above the shaft 122, and therefore will produce the desired shaft rotation from which useful work can be extracted. Although in the idealized diagram of FIG. 3 the blades 126 “flip” at approximately the 180° position, in practice the blades tend to flip a little later in the rotation, for example at approximately 200° rotation.

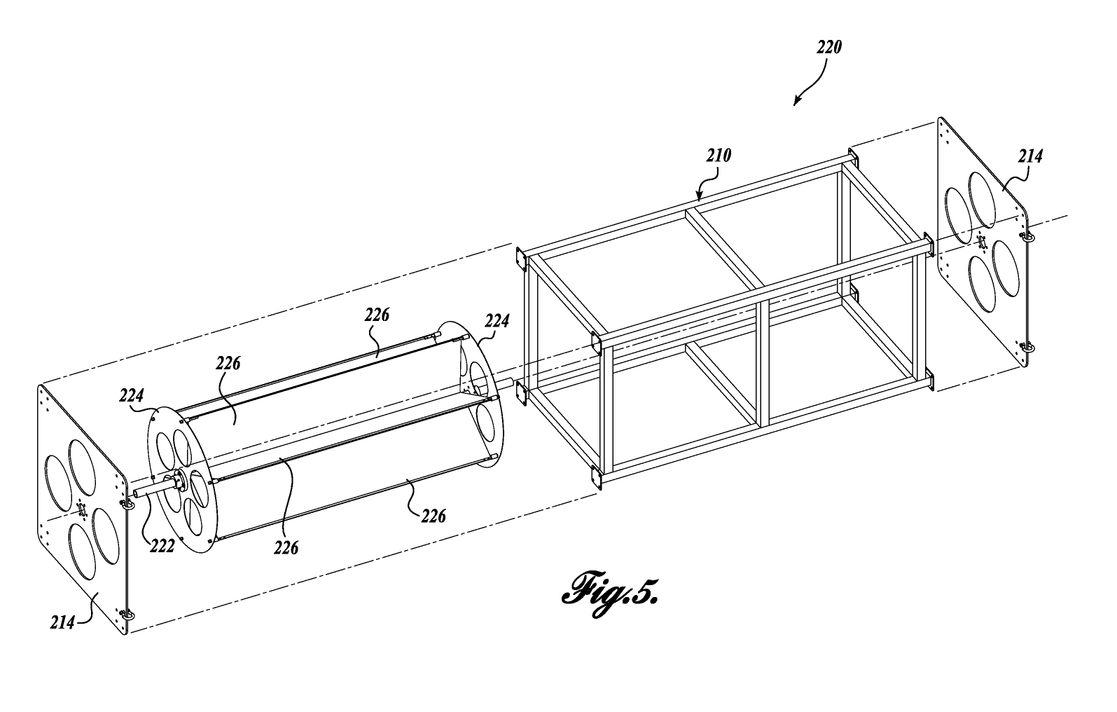

A perspective view of a second embodiment of a turbine 220 in accordance with the present invention is shown in FIG. 4, and an exploded view of the turbine 220 is shown in FIG. 5. Turbine 220 is similar to the turbine 120 described above, except this embodiment utilizes six blades 226 (four are visible) that are pivotably attached to support plates 224 at equally spaced intervals. The turbine 220 is similarly mounted to an open frame structure 210 including end plates 214 to which generators (not shown) may be mounted to engage the driveshaft 222.

As discussed above, the turbine 220 is placed transversely in a flow stream to generate power. The turbine 220 is conveniently rectangular in shape, which makes it ideal for extracting work from many man-made flow streams such as canals, spillways, and the like, wherein the flow is contained in a regularly shaped channel. However, a shaped channel is not required for the turbine to operate, and it is contemplated that the turbine 220 may be used to generate power in a more open body of water, for example to generate power from tidal flows. The turbine 220 is well suited to highly directional flows such as streams and rivers, and in larger-directional flows such as tidal basins and the like.

In the above-described embodiments, for example in the turbine 120 shown in FIG. 2, the power is derived primarily from the water flow engaging blades 126 disposed above the driveshaft 122 axis of rotation. Alternatively, the turbine 120 may be positioned in a reversed orientation (or in a flow that reverses direction, such as in a tidal flow), such that the flow 90 engages the turbine from the left in FIG. 2. It will be appreciated by studying the FIGURES that the turbine 120 will operate in the reversed flow, and the blades 126 will be in the stopped position (and experience high pressure) primarily when the blades 126 are disposed above the driveshaft 122.

It will also be apparent to persons of skill in the art that the turbine 220 may be constructed inexpensively. In particular, the blades are preferably (but not necessarily) substantially planar, and may be formed simply from sheet materials, such as a sheet metal or plastic material. Moreover, the turbine 220 does not rely on flow passing through narrow channels, which could be prone to blockage from foreign matter in the stream. As will be appreciated from FIG. 2 the portion of the flow providing the motive power (the upper portion in FIG. 2) does not flow through any narrow channel, and a relatively wide and open flow paths is provided for the portion of the flow that is not motivating the turbine 220.

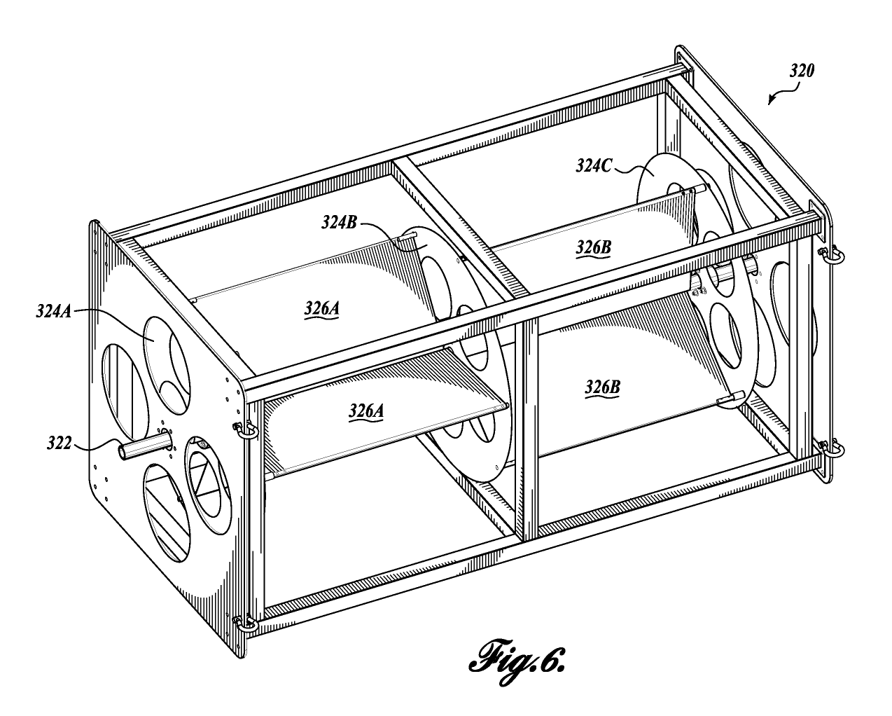

Refer now to FIG. 6, which is a perspective view of another embodiment of a turbine 320 having a first set of blades 326A (three blades 326A in this embodiment, of which two are visible) pivotably attached between and to a proximal support plate 324A and an intermediate support plate 324B. A second similar set of blades 326B are pivotably attached to the intermediate support plate 324B and to a distal support plate 324C. The three support plates 324A, 324B, 324C are fixedly attached to the driveshaft 322, which may drivably engage one or more generators (not shown). The blades 326A, 326B operate in the same manner as described above, wherein the upper blades will produce a rotational force on the shaft 322 when the turbine 320 is placed transversely in a flow stream.

The first set of blades 326A are preferably evenly spaced (i.e., every) 120° and rotationally offset from the second set of blades 326B, for example by 60°. Therefore, in a relatively consistent flow stream the first set of blades 326A and second set of blades 326B will on average be at complementary stages of power production, thereby smoothing out the power produced by the turbine 320. Although two sets of blades 326A, 326B are shown, it will be appreciated that more blade sets may be provided, each set being at a particular rotational orientation. For example, a second intermediate support plate may be provided, and three sets of blades may be provided, each set of blades being pivotably attached between two support plates.

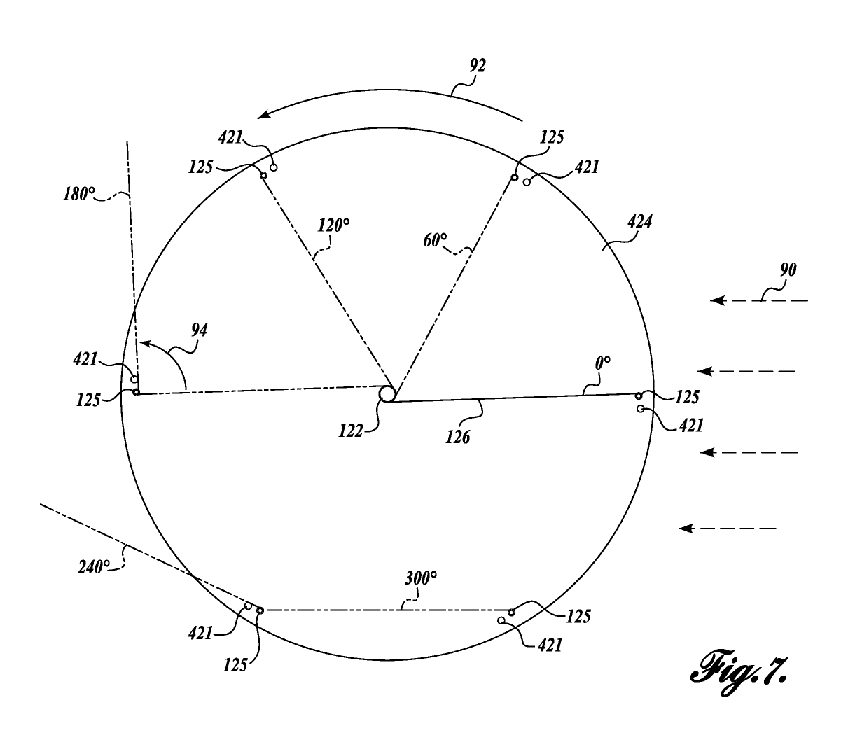

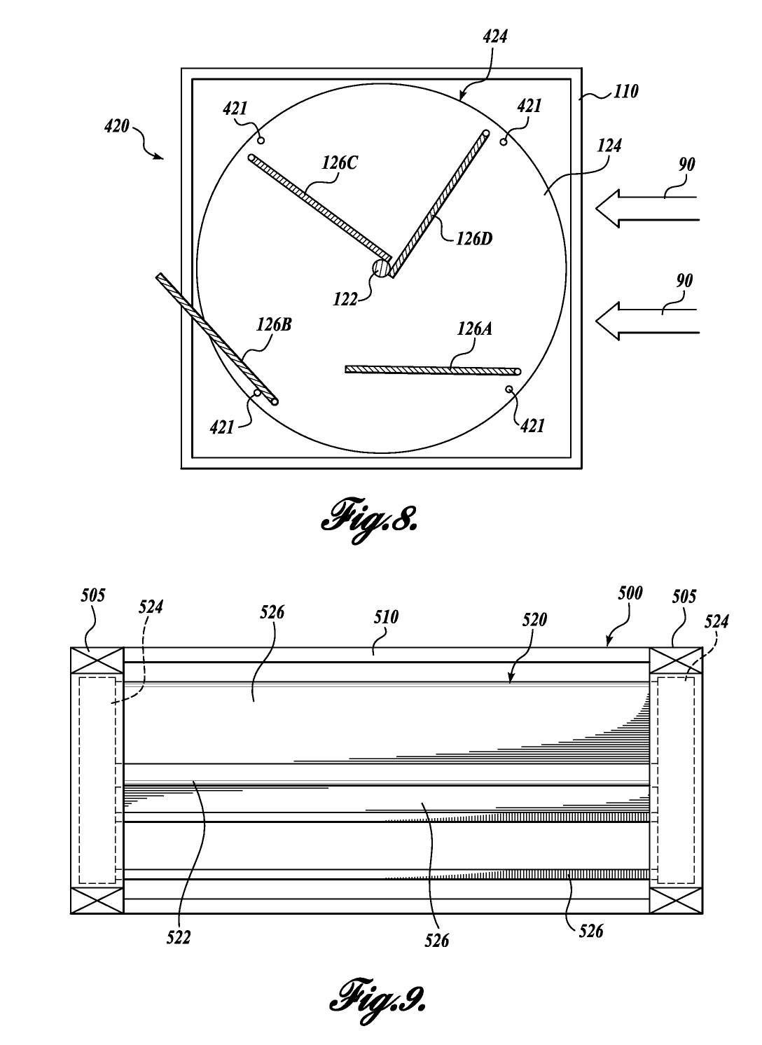

Refer now to FIG. 7, which shows a kinematic diagram similar to FIG. 3, illustrating a single turbine blade 126 at sixty-degree intervals (0°, 60°, 120°, 180°, 240° and) 300° through one rotation of a support plate 424. In this embodiment the support plate 424 further comprises blade stops 421 that are spaced a short distance to one side of the pivot axis 125 of the blades 126. Refer also to FIG. 8, which shows a cross-sectional end view (similar to FIG. 2) of a turbine 420 incorporating the blade stops 421. When the blades are above the axis of rotation of the driveshaft 122 (e.g., blades 126C, 126D), they interact with the flow 90 as disclosed above. However, between approximately the 180° position and approximately the 270° position, (e.g, during the back lower quarter of the revolution) the blade position is limited by the blade stop 421, such that the blade is angled upwardly. In this upwardly angled position (e.g., blade 126B in FIG. 8) the blade will turn the water flow upwardly, generating a higher pressure on the blade 126B, providing additional power. As the support plate 424 passes through approximately the 270° position the blade will no longer engage the stop 421 (e.g., blade 126A). The stops 421 will therefore improve the efficiency of the turbine 420.

FIG. 9 illustrates another embodiment of a power generator system 500 in accordance with the present invention. Excepting for the additional aspects discussed below, the turbine 520 may be substantially similar to any of the turbines described above. In this embodiment, the turbine 520 includes a driveshaft 522 that drivably engages oppositely disposed generator rotors 524. A plurality or turbine blades 526 are pivotably attached to generator rotors 524 near an outer periphery of the rotors 524, and pivot about an axis that is parallel to the axis of the driveshaft 522. The turbine blades 526 are sized and positioned to engage the driveshaft 522 (or a stop located near the driveshaft) such that the turbine 520 will be drivably engaged when suitably placed in a flow stream as discussed above.

Oppositely disposed generator stators 505 are attached to the frame 510 and circumferentially encircle the associated rotor 524, such that as the rotors 524 rotate an electric current will be produced by the generator rotor/stator 524/505 pair. For example, the rotors 524 may comprise a support plate having a plurality of magnets disposed along the outer periphery of the support plate, and the stator may include a plurality of coils configured to have a current induced by the rotating magnets. Other rotor/stator configurations for generating an electrical current will be apparent to persons of ordinary skill in the art. It will be appreciated that in this embodiment the stator diameter is relatively large, which will facilitate electric power generation at relatively low revolution rates. Although the disclosed system 500 is shown with two oppositely disposed generators (524/505) it is contemplated that in other embodiments a single generator may be provided, or additional generators may be provided, for example disposed coaxial with, and outboard of, the generators shown.

Although the embodiments described above disclose the inventor's currently preferred method and apparatus, certain changes may be made without departing from the present invention. For example, it is contemplated that the turbine blades may be curved, for example, about an axis parallel to the blade pivot axis. Such curvature may provide flow advantages (e.g., reduced drag, increased lift). Although generally planar blades are currently preferred, it is also contemplated that the blades may be shaped with a characteristic thickness profile, for example an airfoil shape, to improve performance. In another modification it is contemplated that adjustable and/or dynamically controllable blade stops may be provided to more precisely control the blade position when the blades are disposed on the back side (e.g., downstream) of the driveshaft.

The turbine may be fabricated from any materials suitable for the environment in which the system is intended to operate, including suitable metals, polymeric materials and composite materials. It is contemplated, for example that a system in accordance with the present invention may be placed in a body of water having significant tide-generated flows, with cables to shore provided to receive the electric power generated by the system.

Various embodiments of the present invention will have one or more of the following advantages:
i. A relatively simple mechanical mechanism.
ii. Inexpensive to construct from standard materials.
iii. Rotation in the same direction regardless of the direction of the water flow therefore it is suitable for tidal currents that reverse their direction or for up-and-down motion driven by waves.
iv. May be mounted horizontally or vertically in a flow.
v. Scalability to accommodate different applications.
vi. May fit tightly into most water channels to greatly increase the efficiency of energy generation because most of the water is forced through the rotor instead of going around it.
vii. Safe for fish and aquatic life because it rotates slowly and provides large channels through the turbine.
viii. Reliability because the turbine is difficult to jam with floating debris. Floating flotsam will tend to pass over the top of the turbine.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

The embodiments of the invention in which an exclusive property or privilege is claimed are defined as follows:

1. A water turbine configured to be placed into a flow stream, the turbine comprising:
a frame structure having a first end and a second end;
a shaft rotatably mounted to the frame structure to rotate about a shaft axis;
a first support plate fixedly attached to the shaft near the first end of the frame structure and a second support plate fixedly attached to the shaft a distance away from the first support plate; and
a plurality of first blades pivotably connected to a peripheral portion of the first and second support plates, each blade having a distal edge that is disposed adjacent the shaft when the blade is pivoted to a stopped position,
wherein during operation of the water turbine the first blades revolve about the shaft axis, and wherein each blade is held in the stopped position by the flow stream for a portion of the revolution and is pivoted away from the stopped position by the flow stream for the remainder of the revolution.

2. The water turbine of claim 1, wherein the plurality of first blades comprise at least four blades.

3. The water turbine of claim 1, wherein the plurality of first blades are evenly spaced around the first and second support plates.

4. The water turbine of claim 1, wherein each of the first blades pivot about an axis that is parallel to the shaft axis.

5. The water turbine of claim 1, wherein the first blades are planar.

6. The water turbine of claim 1, wherein the distal edge of each blade of the plurality of first blades is adjacent the shaft when the blade is in the stopped position.

7. The water turbine of claim 1, wherein the frame structure comprises a substantially rectangular open structure.

8. The water turbine of claim 1, further comprising a plurality of blade stops attached to the first support plate, each blade stop being associated with one of the plurality of first blades and being positioned a distance from the pivot axis of the associated first blade such that the blade stop limits the outward pivot of the associated blade during the operation of the water turbine.

9. The water turbine of claim 1, further comprising a third support plate fixedly attached to the shaft near the second end of the frame structure, and a plurality of second blades, each second blade having a proximal edge that is pivotably attached to a peripheral portion of the second and third support plates and each second blade further comprises a distal edge that is disposed adjacent the shaft when the second blade is pivoted to a stopped position.

10. The water turbine of claim 9, wherein the plurality of second blades are attached to the second and third support plates at an angular position offset from the plurality of first blades.

11. The water turbine of claim 1, wherein the first support plate is configured as a rotor for an electric generator.

12. The water turbine of claim 11, wherein the first support plate further comprises a plurality of magnets disposed about an outer perimeter of the first support plate.

13. The water turbine of claim 1, further comprising an electric power generator attached to the frame structure and drivably engaged by the shaft.

14. A hydroelectric power generator configured to be submerged in a flow stream, the hydroelectric power generator comprising:
an electric power generator that is drivably attached to a water turbine, wherein the water turbine comprises:
a frame structure having a first end and a second end;
a shaft rotatably mounted to the frame structure to rotate about a shaft axis;
a first support plate fixedly attached to the shaft near the first end of the frame structure and a second support plate fixedly attached to the shaft a distance away from the first support plate; and
a plurality of first blades pivotably connected to a peripheral portion of the first and second support plates, each blade having a distal edge that is disposed adjacent the shaft when the blade is pivoted to a stopped position,
wherein during operation of the water turbine the first blades revolve about the shaft axis, and wherein each blade is held in the stopped position by the flow stream for a portion of the revolution and is pivoted away from the stopped position by the flow stream for the remainder of the revolution.

15. The hydroelectric power generator of claim 14, wherein each of the first blades pivot about an axis that is parallel to the shaft axis.

16. The hydroelectric power generator of claim 14, wherein the first blades are planar.

17. The hydroelectric power generator of claim 14, wherein the distal edge of each blade is adjacent the shaft when the blade is in the stopped position.

18. The hydroelectric power generator of claim 14, further comprising a plurality of blade stops attached to the first support plate, each blade stop being associated with one of the plurality of first blades and being positioned a distance from the pivot axis of the associated first blade such that the blade stop limits the outward pivot of the associated blade during the operation of the water turbine.

19. The hydroelectric power generator of claim 14, further comprising a third support plate fixedly attached to the shaft near the second end of the frame structure, and a plurality of second blades, each second blade having a proximal edge that is pivotably attached to a peripheral portion of the second and third support plates and each second blade further comprising a distal edge that is disposed adjacent the shaft when the second blade is pivoted to a stopped position.

20. The hydroelectric power generator of claim 19, wherein the plurality of second blades are attached to the second and third support plates at an angular position offset from the plurality of first blades.
